(19) United States
(12) Patent Application Publication
(10) Pub. No.: US 2025/0102001 A1
(43) Pub. Date: Mar. 27, 2025

(54) MACHINE-PART MATING STRUCTURE

(71) Applicant: FANUC CORPORATION, Yamanashi (JP)

(72) Inventor: Masahiro YAMAMOTO, Yamanashi (JP)

(21) Appl. No.: 18/729,683

(22) PCT Filed: Jan. 27, 2022
(86) PCT No.: PCT/JP2022/003115

§ 371 Date: Jul. 17, 2024

(51) Int. Cl. F16B 4/00

(52) U.S. Cl. CPC F16B 4/004

(57) ABSTRACT

A machine-part mating structure is for mating a columnar shaft with a mating hole in an axial direction. The mating hole includes at least two mating regions arranged side-by-side in the axial direction in a mating area, in which the mating hole is mated with the shaft, extending in the axial direction. Of the mating regions, an inner diameter, at an upper tolerance limit, of a first mating region located on an inner side of the mating hole is smaller than an inner diameter, at a lower tolerance limit, of a second mating region located closer to an inlet of the mating hole than the first mating region. The second mating region is dimensioned in the axial direction so that the shaft is allowed to smoothly enter the first mating region even if the shaft is inclined to a maximum angle with respect to an axis of the mating hole.

### CROSS-REFERENCE TO RELATED APPLICATION(S)

This is a National Stage Entry into the United States Patent and Trademark Office from International Patent Application No. PCT/JP2022/003115, filed on Jan. 27, 2022, the entire content of which is incorporated herein by reference.

### FIELD OF THE INVENTION

The present disclosure relates to a machine-part mating structure.

### BACKGROUND OF THE INVENTION

Conventionally, when a torque sensor is attached to a robot arm, in order to align the axis of the torque sensor with the axis of the robot arm, the torque sensor, which is columnar, is mated with the inside of a tubular portion of the robot arm (for example, see Japanese Unexamined Patent Application, Publication No. 2020-12656).

When the outer surface of the columnar torque sensor is mated with the inner surface of the tubular portion of the robot arm over a long distance in the axial direction, a bending moment or a load other than torque is detected, lowering the detection accuracy. To solve this inconvenience, in Japanese Unexamined Patent Application, Publication No. 2020-12656, the outer surface of the torque sensor and the inner surface of the robot arm are brought into contact with each other at a portion thereof in the axial direction. Specifically, only a portion of the outer circumferential surface of the torque sensor in the axial direction is made to project radially outward, or the inner circumferential surface of the robot arm is formed of a tapered curved surface.

### SUMMARY OF INVENTION

One aspect of the present disclosure is a machine-part mating structure for mating a columnar shaft with a mating hole in an axial direction. The mating hole includes at least two mating regions arranged side-by-side in the axial direction in a mating area, in which the mating hole is mated with the shaft, extending in the axial direction. Of the mating regions, an inner diameter, at an upper tolerance limit, of a first mating region located on an inner side of the mating hole is smaller than an inner diameter, at a lower tolerance limit, of a second mating region located closer to an inlet of the mating hole than the first mating region is. The second mating region has such a tolerance and a length in the axial direction that the shaft is allowed to smoothly enter the first mating region even if the shaft is inclined to a maximum angle with respect to an axis of the mating hole, on the basis of a clearance between an inner surface of the mating hole and an outer surface of the shaft in the second mating region.

### BRIEF DESCRIPTION OF DRAWINGS

FIG. 1 is a longitudinal cross-section illustrating a machine-part mating structure according to a first embodiment of the present disclosure.

FIG. 2 is a partial longitudinal cross-section illustrating the diameters of a shaft and a mating hole in the mating structure in FIG. 1.

FIG. 3 is a longitudinal cross-section for explaining a clearance in the radial direction between the shaft and the mating hole in the mating structure in FIG. 1.

FIG. 4 is a longitudinal cross-section for explaining the inclination of the shaft with respect to the axis of the mating hole in the mating structure in FIG. 1.

FIG. 5 is a longitudinal cross-section for explaining a machine-part mating structure according to a second embodiment of the present disclosure.

FIG. 6 is a partial longitudinal cross-section illustrating the diameters of the shaft and the mating hole in the mating structure in FIG. 5.

FIG. 7 is a longitudinal cross-section for explaining a clearance in the radial direction between the shaft and the mating hole in the mating structure in FIG. 5.

### DESCRIPTION OF EMBODIMENT(S) OF THE INVENTION

A machine-part mating structure 1 according to a first embodiment of the present disclosure will be described below with reference to the drawings.

The machine-part mating structure 1 according to this embodiment is, for example, a mating structure between two machine part 10, 20, provided in a robot.

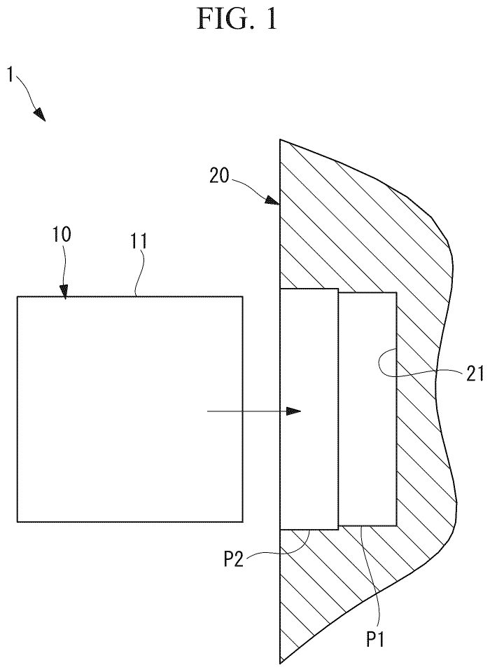

As illustrated in FIG. 1, the first machine part (machine part) 10 includes, for example, a columnar shaft 11 having a constant outer diameter, and the second machine part (machine part) 20 includes, for example, a mating hole 21 having a circular lateral cross-section with which the shaft 11 is mated in the axial direction.

The outer diameter of the shaft 11 and the inner diameter of the mating hole 21 have a common reference dimension. The shaft 11 and the mating hole 21 are mated with each other over a predetermined mating area in the axial direction.

The outer diameter of the shaft 11 has a single reference dimension and a set of tolerances in the mating area. The tolerances of the shaft 11 indicate the range of dimensional variation with respect to the reference dimension and are biased toward the negative side with respect to the reference dimension, so that the shaft 11 can also be mated with a mating hole 21 formed to have an inner diameter at the lower tolerance limit.

Meanwhile, the mating hole 21 has at least two mating regions P1 and P2 arranged side-by-side in the axial direction in the mating area. As illustrated in FIG. 1, the two mating regions P1 and P2 are: a first mating region P1 disposed on the inner side of the mating hole 21 (in the direction in which the shaft 11 is mated with the mating hole 21); and a second mating region P2 disposed closer to the inlet of the mating hole 21 (on the front side in the direction in which the shaft 11 is mated with the mating hole 21) than the first mating region P1 is.

The inner diameters of the first mating region P1 and the second mating region P2 have common reference dimensions As and Bs and have different tolerances. As illustrated in an exaggerated manner in FIG. 1, the inner diameter of the first mating region P1 at the upper tolerance limit is set to be smaller than the inner diameter of the second mating region P2 at the lower tolerance limit.

In other words, the inner diameter of the first mating region P1 and the inner diameter of the second mating region P2 have the common reference dimensions As and Bs, but the tolerance zones thereof do not overlap. Hence, the mating hole 21 is formed while the machining conditions are changed in the middle of the mating area in the axial direction.

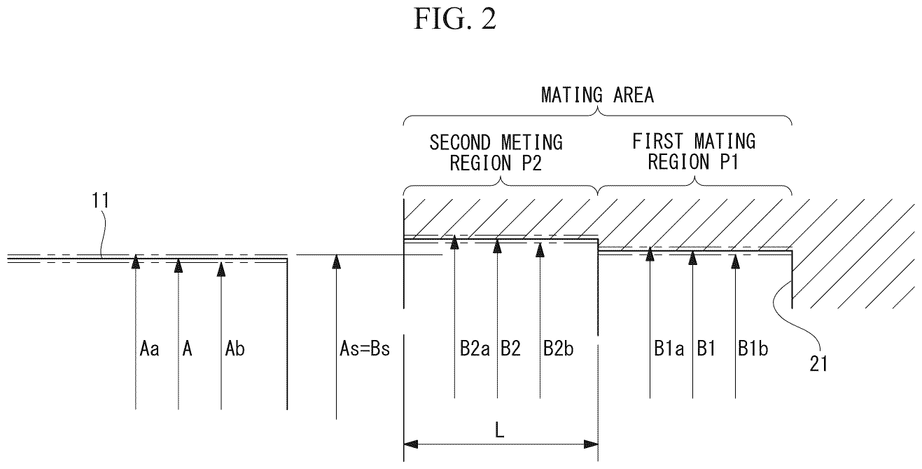

Specifically, as illustrated in FIG. 2, the mating structure 1 according to this embodiment has the following relationship:

A<B1<B2

B1a<B2b
where A is the outer diameter of the shaft 11, B1 is the inner diameter of the first mating region P1, B2 is the inner diameter of the second mating region P2, B1a is the inner diameter of the first mating region P1 at the upper tolerance limit, B2b is the inner diameter of the second mating region P2 at the lower tolerance limit.

The outer diameter A of the shaft 11 has the relationship Ab≤A≤Aa, where Aa is the outer diameter at the upper tolerance limit, and Ab is the outer diameter at the lower tolerance limit.

The inner diameter B1 of the first mating region P1 of the mating hole 21 has the relationship B1b≤B1≤B1a, where B1a is the inner diameter at the upper tolerance limit, and B1b is the inner diameter at the lower tolerance limit.

The inner diameter B2 of the second mating region P2 of the mating hole 21 has the relationship B2b≤B2≤B2a, where B2a is the inner diameter at the upper tolerance limit, and B2b is the inner diameter at the lower tolerance limit.

As described above, because the outer diameter A of the shaft 11 has the tolerances biased toward the negative side with respect to the reference dimension As, in both cases where the shaft 11 is mated with the first mating region P1 and where the shaft 11 is mated with the second mating region P2, a clearance is left between the shaft 11 and the inner surface of the mating hole 21. The clearance in the radial direction between the outer surface of the shaft 11 and the inner surface of the mating hole 21 is larger in the second mating region P2, which has a larger inner diameter B2, than in the first mating region P1, which has a smaller inner diameter B1.

When the shaft 11 is mated with the mating hole 21, the end of the shaft 11 is inserted into the mating hole 21 from the inlet side of the mating hole 21 and is first mated with the second mating region P2 located on the inlet side. Then, in a state in which the mating has progressed until the overall length of the shaft 11 is mated with the second mating region P2 in the axial direction, mating with the first mating region P1, which is located farther on the inner side of the mating hole 21 than the second mating region P2, is started.

In this embodiment, the inner diameter B2a of the second mating region P2 at the upper tolerance limit and the axial length L are set as follows.

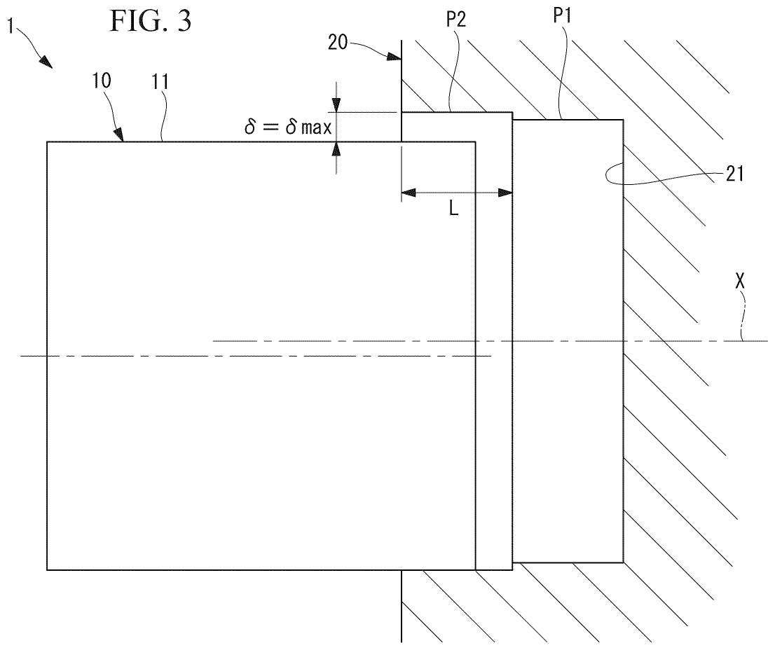

FIG. 3 shows a case where the outer diameter A of the shaft 11 is the outer diameter Ab at the lower tolerance limit, and the inner diameter B2 of the second mating region P2 is the inner diameter B2a at the upper tolerance limit. In this case, the clearance δ formed between the inner surface of the mating hole 21 and the outer surface of the shaft 11 is a maximum value δmax.

$$δ max = B 2 a - Ab$$

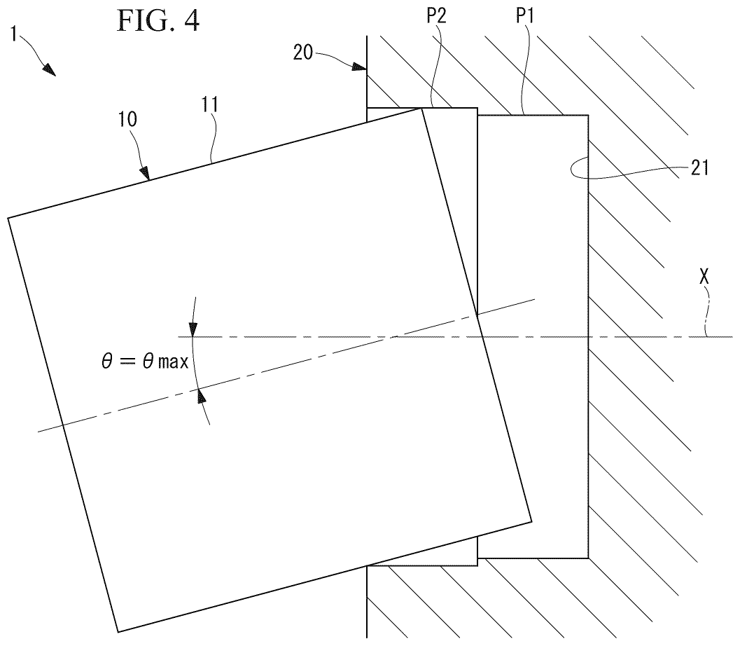

FIG. 4 shows a state immediately before the shaft 11 starts to be mated with the first mating region P1, that is, a state in which the shaft 11 is mated with the second mating region P2 over the overall length thereof in the axial direction, and the mating length is the length L of the second mating region P2 in the axial direction. In this case, the shaft 11 may be inclined by the maximum angle θmax with respect to the axis X of the mating hole 21.

$$θ max = {tan}^{- 1} ( δmax / L )$$

In the mating structure 1 according to this embodiment, the tolerances and the length L are set such that, even if the shaft 11 mated only with the second mating region P2 is inclined to the maximum angle θmax with respect to the axis X of the mating hole 21, the subsequent portion of the shaft 11 is allowed to smoothly enter the first mating region P1. Here, smooth entry of the shaft 11 to the first mating region P1 means entry without causing so-called “galling”, in which the shaft 11 and the first mating region P1 bite each other and cannot be separated from each other.

In the first mating region P1, the clearance δ is preferably as close to 0 as possible in terms of improvement in the radial positioning accuracy. However, in reality, in order to mate the shaft 11 with the mating hole 21, there needs to be a positive clearance δ.

In order to allow the shaft 11 to smoothly enter the first mating region P1 of the mating hole 21, the maximum angle θmax of the shaft 11 with respect to the axis X of the mating hole 21 at the start of entry needs to be small. As a result of examining various reference dimensions of the shafts 11 and the mating holes 21 to be used practically, tolerances, and lengths L of the second mating regions P2, it has been found that the maximum angle θmax that allows smooth entry of the shaft 11 to the first mating region P1 of the mating hole 21 is preferably θmax≤1°.

The operation of the thus-configured machine-part mating structure 1 according to this embodiment will be described below.

According to the machine-part mating structure 1 according to this embodiment, when the shaft 11 is mated with the mating hole 21, the shaft 11 is first mated with the second mating region P2 located on the inlet side of the mating hole 21. Because the second mating region P2 has a larger inner diameter than the first mating region P1 located on the inner side of the mating hole 21, the clearance δ with respect to the shaft 11 mated therewith is larger than that between the first mating region P1 and the shaft 11.

Hence, in the second mating region P2, with which the shaft 11 is mated before being mated with the first mating region P1 after mating with the mating hole 21 is started, even if the shaft 11 is inclined at a relatively large angle with respect to the axis X of the mating hole 21, the mating can be proceeded without causing galling.

The inclination θ of the shaft 11 with respect to the axis X of the mating hole 21 at the time when mating with the first mating region P1 is started after completion of mating with the second mating region P2 has such a reference dimension, tolerance, and length L that they do not cause galling in the first mating region P1. Hence, the shaft 11 directly and smoothly shifts from mating with the second mating region P2 to mating with the first mating region P1, and the shaft 11 can also be mated with the first mating region P1 without causing galling.

Here, as an example of the practical outer diameter A of the shaft 11 and the practical inner diameters B1 and B2 of the mating hole 21, three cases where the reference dimension Bs=100, 120, and 150 will be described. Here, an example case where the tolerance zone of the outer diameter A of the shaft 11 is h7, the tolerance zone of the inner diameter B1 of the first mating region P1 of the mating hole 21 is F7, and the tolerance zone of the inner diameter B2 of the second mating region P2 is H7 will be described on the basis on the Japanese Industrial Standard (JIS B0401).

$$If As = Bs = 100 , then$$

$$Ab = 99.965 \leq A \leq A a = 1 \; 00 ,$$

$$B 1 b = 100 \leq B 1 \leq B 1 a = 100.035 , and$$

$$B 2 b = 100.036 \leq B 2 \leq B 2 a = 100.071 .$$

Hence, in the second mating region P2, the maximum value δmax of the clearance in the radial direction between the shaft 11 and the mating hole 21 is:

$$δ max = 100.0 \; 71 - 99. 965 = 0.106 .$$

When the length L of the second mating region P2 in the axis X direction is 6 mm, the maximum angle θmax of the shaft 11 that is mated with the second mating region P2 and immediately before being mated with the first mating region P1 is:

$$θ max = {tan}^{- 1} ( 0.1 \; 06 / 6 ) = 1. ° .$$

If As=Bs=120, then

$$Ab = 119.965 \leq A \leq A a = 1 \; 20 ,$$

$$B 1 b = 120 \leq B 1 \leq B 1 a = 120.035 , and$$

$$B 2 b = 120.036 \leq B 2 \leq B 2 a = 120.071 .$$

Hence, in the second mating region P2, the maximum value δmax of the clearance in the radial direction between the shaft 11 and the mating hole 21 is:

$$δ max = 120.0 \; 71 - 11 \; 9.965 = 0.106 .$$

When the length L of the second mating region P2 in the axis X direction is 8 mm, the maximum angle θmax of the shaft 11 that is mated with the second mating region P2 and immediately before being mated with the first mating region P1 is:

$$θ max = {tan}^{- 1} ( 0.1 \; 06 / 8 ) = 0.76 ° \leq 1 ° .$$

If As=Bs=150, then

$$Ab = 149.960 \leq A \leq A a = 1 \; 50 ,$$

$$B 1 b = 150 \leq B 1 \leq B 1 a = 150.04 , and$$

$$B 2 b = 150.043 \leq B 2 \leq B 2 a = 150.083 .$$

Hence, in the second mating region P2, the maximum value δmax of the clearance in the radial direction between the shaft 11 and the mating hole 21 is:

$$δ max = 150.0 \; 83 - 14 \; 9.960 = 0.123 .$$

When the length L of the second mating region P2 in the axis X direction is 8.2 mm, the maximum angle θmax of the shaft 11 that is mated with the second mating region P2 and immediately before being mated with the first mating region P1 is:

$$θ max = {tan}^{- 1} ( 0.1 \; 23 / 8.2 ) = 0.86 ° \leq 1 ° .$$

In practice, with the shaft 11 and the mating hole 21 having the above-described reference dimensions, tolerances, and lengths of the second mating region P2, the shaft 11 can be smoothly mated without causing galling from the start of mating with the second mating region P2 of the mating hole 21 to the completion of mating with the first mating region P1. Hence, in various reference dimensions, the reference dimensions, the tolerances, and the lengths L can be set such that the maximum angle θmax of the shaft 11 that is mated with the second mating region P2 and immediately before being mated with in the first mating region P1 is θmax≤1°. Setting in this way provides advantages in that it is possible to easily start mating of the shaft 11 with the mating hole 21, it is possible to smoothly proceed mating until mating is completed, and it is possible to achieve high positioning accuracy in the radial direction in the finally mated state.

In this embodiment, an example case where, in practice, the shaft 11 can be smoothly mated without causing galling from the start of mating with the second mating region P2 of the mating hole 21 to the completion of mating with the first mating region P1 has been described. Instead of this, other reference dimensions, tolerances, and lengths L of the second mating region P2 that satisfy the above-described conditions may be adopted.

Specifically, in order to achieve mating with the first mating region P1 without causing galling while maintaining ease of mating of the shaft 11 with the second mating region P2, the length L of the second mating region P2 may be increased. If the length L of the second mating region P2 cannot be increased, the dimensional tolerance in the radial direction in the second mating region P2 may be adjusted so as to be smaller to the extent that ease of mating can be ensured.

In this embodiment, it is preferable that the dimensional difference ΔB between the inner diameter B1b of the first mating region P1 at the lower tolerance limit and the inner diameter B2a of the second mating region P2 at the upper tolerance limit is 0.1% or less of the reference dimension Bs of the inner diameter of the first mating region P1. This reduces the step between the first mating region P1 and the second mating region P2, allowing a smooth transition from mating with the second mating region P2 to mating with the first mating region P1.

In the above example, if Bs=100, then

$$Δ B = B 2 a - B 1 b = 100.071 - 100 = 0 \text{.071}$$

$$Δ B / Bs = 0.071 / 100 = 0.00071 \leq 0.1 \% .$$

If Bs=120, then

$$Δ B = B 2 a - B 1 b = 120.71 - 120 = 0 \text{.071}$$

$$Δ B / Bs = 0.071 / 120 = 0.00059 \leq 0.1 \% .$$

If Bs=150, then

$$Δ B = B 2 a - B 1 b = 150.083 - 150 = 0 \text{.083}$$

$$Δ B / Bs = 0.083 / 150 = 0.00055 \leq 0.1 \% .$$

In this embodiment, the mating structure 1 for mating the shaft 11 with the mating hole 21, the shaft 11 being provided on the first machine part 10 and the mating hole 21 being provided in the second machine part 20, has been described. The machine parts 10 and 20 in this case are assumed to be machine parts provided in a robot, but may be any other machine parts. In particular, one of the first machine part 10 and the second machine part 20 may be a machine part, such as an arm or a housing, constituting a robot, and the other may be a sensor for detecting force, torque, temperature, or the like.

Next, a machine-part mating structure 50 according to a second embodiment of the present disclosure will be described below with reference to the drawings.

In the description of this embodiment, the same reference numerals denote portions having the same configuration as those of the machine-part mating structure 1 according to the first embodiment described above, and the description thereof will be omitted.

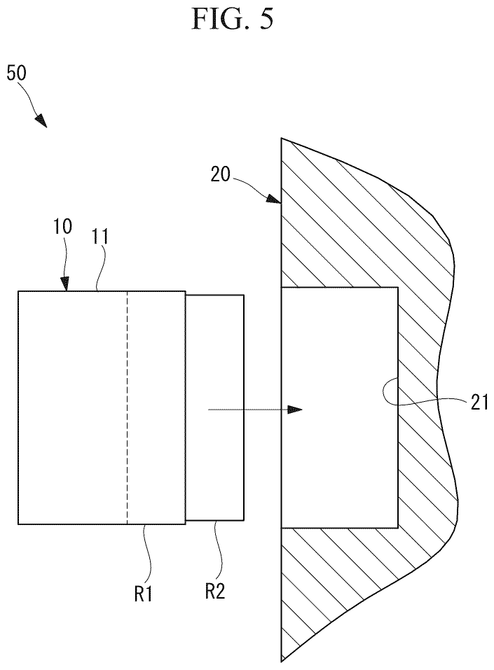

As illustrated in FIG. 5, the machine-part mating structure 50 according to this embodiment differs from the first embodiment in that the mating hole 21 has an inner diameter B with a single tolerance, and the shaft 11 has two mating regions R1 and R2 arranged side-by-side in the Y-axis direction. The inner diameter of the mating hole 21 in the mating area has a single reference dimension and a set of tolerances. The tolerances of the mating hole 21 indicates the range of dimensional variation with respect to the reference dimension and are biased toward the positive side with respect to the reference dimension, so that the shaft 11 manufactured to have an outer diameter at the upper tolerance limit can also be mated.

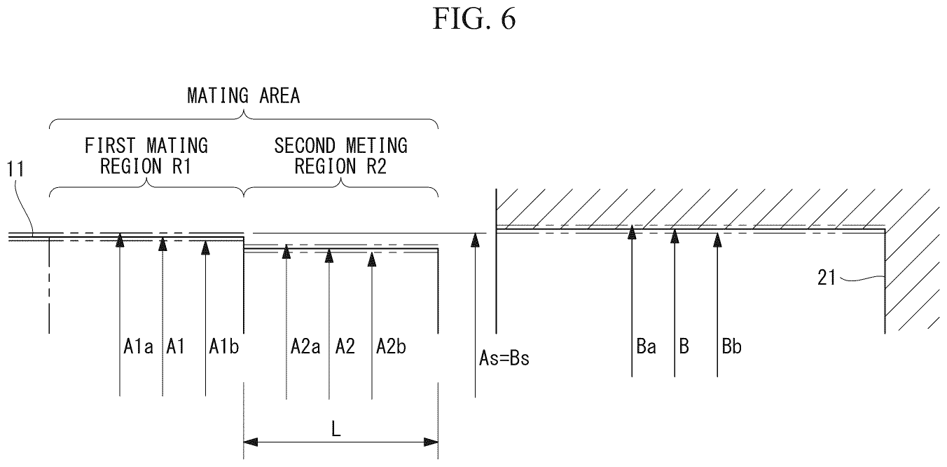

As illustrated in FIG. 6, the two mating regions R1 and R2 of the shaft 11 are a first mating region R1 located on the proximal side of the shaft 11 and a second mating region R2 located closer to the distal end of the shaft 11 than the first mating region R1.

The outer diameter A1 of the first mating region R1 and the outer diameter A2 of the second mating region R2 have common reference dimensions As and Bs and have different tolerances. The outer diameter A2a of the second mating region R2 at the upper tolerance limit is set to be smaller than the outer diameter A1b of the first mating region R1 at the lower tolerance limit.

In other words, the outer diameter A1 of the first mating region R1 and the outer diameter A2 of the second mating region R2 have the common reference dimensions As and Bs, but the tolerance zones thereof do not overlap. Hence, the shaft 11 is formed while the machining conditions are changed in the middle of the mating area in the Y-axis direction.

Specifically, the mating structure 50 according to this embodiment has the following relationship:

$$A 2 < A 1 < B$$

$$A 2 a < A 1 b$$

where A1 is the outer diameter of the first mating region R1 of the shaft 11, A2 is the outer diameter of the second mating region R2 of the shaft 11, A2a is the outer diameter of the second mating region R2 at the upper tolerance limit, A1b is the outer diameter of the first mating region R1 at the lower tolerance limit, and B is the inner diameter of the mating hole 21.

The inner diameter B of the mating hole 21 has the relationship Bb≤B≤Ba, where Ba is the inner diameter at the upper tolerance limit, and Bb is the inner diameter at the lower tolerance limit.

The outer diameter A1 of the first mating region R1 of the shaft 11 has the relationship A1b≤A1≤A1a, where A1a is the outer diameter at the upper tolerance limit, and A1b is the outer diameter at the lower tolerance limit.

The outer diameter A2 of the second mating region R2 of the shaft 11 has the relationship A2b≤A2≤A2a, where A2a is the outer diameter at the upper tolerance limit, and A2b is the outer diameter at the lower tolerance limit.

As described above, because the inner diameter B of the mating hole 21 has the tolerances biased toward the positive side with respect to the reference dimension Bs, in both cases where the first mating region R1 of the shaft 11 is mated and where the second mating region R2 of the shaft 11 is mated, a clearance is left between the mating hole 21 and the outer surface of the shaft 11. The clearance in the radial direction between the outer surface of the shaft 11 and the inner surface of the mating hole 21 is larger in the second mating region R2, which has a smaller outer diameter A2, than in the first mating region R1, which has a larger outer diameter A1.

When the shaft 11 is mated with the mating hole 21, the end of the shaft 11 is inserted into the mating hole 21 from the inlet side of the mating hole 21, and the second mating region R2 located at the distal end is mated first. Then, in a state in which the mating has progressed until the overall length of the second mating region R2 is mated with the mating hole 21 in the Y-axis direction, mating of the first mating region R1, which is located closer to the proximal end of the shaft 11 than the second mating region R2 is, with the mating hole 21 is started.

In this embodiment, the outer diameter A2a of the second mating region R2 at the upper tolerance limit and the length L of the second mating region R2 in the Y-axis direction are set as follows.

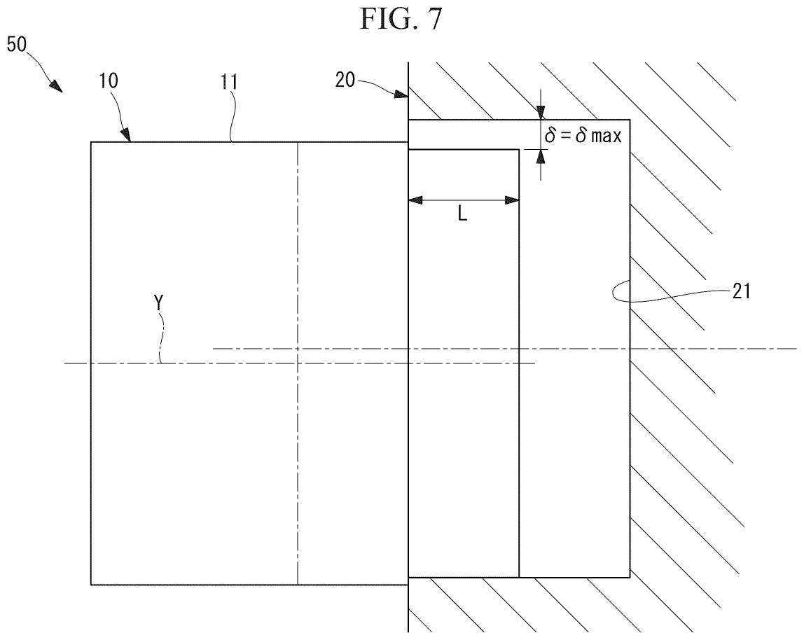

As illustrated in FIG. 7, when the outer diameter A2 of the second mating region R2 of the shaft 11 is the outer diameter A2b at the lower tolerance limit, and the inner diameter B of the mating hole 21 is the inner diameter Ba at the upper tolerance limit, the clearance & formed between the inner surface of the mating hole 21 and the outer surface of the shaft 11 is a maximum value δmax.

$$δ max = B a - A 2 b$$

In a state immediately before mating of the first mating region R1 of the shaft 11 with the mating hole 21 is started, that is, when the overall length of the second mating region R2 of the shaft 11 in the Y-axis direction is mated with the mating hole 21 and the mating length is equal to the length L of the second mating region R2 in the Y-axis direction, the shaft 11 may be inclined by the maximum angle θmax with respect to the axis X of the mating hole 21.

$$θ max = {tan}^{- 1} ( δmax / L )$$

In the mating structure 50 according to this embodiment, the tolerance B2a and the length L are set such that, even if the shaft 11, in which only the second mating region R2 is mated with the mating hole 21, is inclined to the maximum angle θmax with respect to the axis X of the mating hole 21, the subsequent first mating region R1 of the shaft 11 can be allowed to smoothly enter the mating hole 21. Here, smooth entry of the first mating region R1 of the shaft 11 to the mating hole means entry without causing so-called “galling”, in which the first mating region R1 of the shaft 11 and the mating hole 21 bite each other and cannot be separated from each other.

In the first mating region R1, the clearance δ is preferably as close to 0 as possible in terms of improvement in the radial positioning accuracy. However, in order to actually mate the shaft 11 with the mating hole 21, there needs to be a positive clearance δ.

In order to allow the first mating region R1 of the shaft 11 to smoothly enter the mating hole 21, the maximum angle θmax of the shaft 11 with respect to the axis X of the mating hole 21 at the start of entry needs to be small. As a result of examining various reference dimensions of the shafts 11 and the mating holes 21 to be used practically, tolerances, and the lengths L of the second mating regions R2, it has been found that the maximum angle θmax that allows smooth entry of the first mating region R1 of the shaft 11 to the mating hole 21 is preferably θmax≤1°.

The operation of the thus-configured machine-part mating structure 50 according to this embodiment will be described below.

According to the machine-part mating structure 50 according to this embodiment, when the shaft 11 is mated with the mating hole 21, the second mating region R2 located at the distal end of the shaft 11 is first mated from the inlet side of the mating hole 21. Because the second mating region R2 has a smaller outer diameter than the first mating region R1 located on the proximal side of the shaft 11, the clearance with respect to the shaft 11 mated therewith is larger than that in the first mating region R1.

Hence, in the second mating region R2, which is mated before the first mating region R1 of the shaft 11 is mated with the mating hole 21, even if the shaft 11 is inclined at a relatively large angle with respect to the axis X of the mating hole 21, the mating can be proceeded without causing galling.

The inclination θ of the shaft 11 with respect to the axis X of the mating hole 21 at the time when mating of the first mating region R1 is started after completion of mating of the second mating region R2 with the mating hole 21 has such a reference dimension, tolerance, and length L that they do not cause galling between the first mating region R1 and the mating hole 21. Hence, the shaft 11 directly and smoothly shifts from mating of the second mating region R2 of the shaft 11 with the mating hole 21 to mating of the first mating region R1 with the mating hole 21, and the first mating region R1 of the shaft 11 can also be mated with the mating hole 21 without causing galling.

Furthermore, in various reference dimensions, the reference dimensions, the tolerances, and the lengths L can be set such that the maximum angle θmax of the shaft 11 in which the second mating region R2 of the shaft 11 is mated with the mating hole 21 and immediately before the first mating region R1 is mated with the mating hole 21 is θmax≤1°. Setting in this way provides advantages in that it is possible to easily start mating of the shaft 11 with the mating hole 21, it is possible to smoothly proceed with mating until mating is completed, and it is possible to achieve high positioning accuracy in the radial direction in the finally mated state.

In this embodiment, it is preferable that the dimensional difference ΔA between the outer diameter A1b of the first mating region R1 of the shaft 11 at the lower tolerance limit and the outer diameter A2a of the second mating region R2 at the upper tolerance limit be 0.1% or less of the reference dimension As of the inner diameter of the first mating region R1. This reduces the step between the first mating region R1 and the second mating region R2, allowing smooth transition from mating of the second mating region R2 with the mating hole 21 to mating of the first mating region R1 with the mating hole 21.

1. A machine-part mating structure for mating a columnar shaft with a mating hole in an axial direction, wherein
the mating hole includes at least two mating regions arranged side-by-side in the axial direction in a mating area, in which the mating hole is mated with the shaft, extending in the axial direction,
of the mating regions, an inner diameter, at an upper tolerance limit, of a first mating region located on an inner side of the mating hole is smaller than an inner diameter, at a lower tolerance limit, of a second mating region located closer to an inlet of the mating hole than the first mating region is, and
the second mating region has such a tolerance and a length in the axial direction that the shaft is allowed to smoothly enter the first mating region even if the shaft is inclined to a maximum angle with respect to an axis of the mating hole, on the basis of a clearance between an inner surface of the mating hole and an outer surface of the shaft in the second mating region.

2. The machine-part mating structure according to claim 1, satisfying the following relationship:
$$A < B 1 < B 2$$
$$B 1 a < B 2 b$$
where A is an outer diameter of the shaft, B1 is the inner diameter of the first mating region, B2 is the inner diameter of the second mating region, B1a is the inner diameter of the first mating region at the upper tolerance limit, and B2b is the inner diameter of the second mating region at the lower tolerance limit.

3. The machine-part mating structure according to claim 1, wherein the mating hole has the same reference dimension in a radial direction as the shaft.

4. The machine-part mating structure according to claim 3, satisfying the following relationship:
$$( B 2 a - B 1 b ) / Bs \leq 0.001$$
where Bs is the reference dimension of an inner diameter of the mating hole, B2a is the inner diameter of the second mating region at the upper tolerance limit, and B1b is the inner diameter of the first mating region at the lower tolerance limit.

5. A machine-part mating structure for mating a columnar shaft with a mating hole, wherein
the shaft includes at least two mating regions arranged side-by-side in an axial direction in a mating area, in which the shaft is mated with the mating hole, extending in the axial direction,
of the mating regions, an outer diameter, at a lower tolerance limit, of a first mating region located on a proximal side of the shaft is larger than an outer diameter, at an upper tolerance limit, of a second mating region located closer to a distal end than the first mating region is, and
the second mating region has such a tolerance and a length in the axial direction that the first mating region is allowed to smoothly enter the mating hole even if the shaft is inclined to a maximum angle with respect to an axis of the mating hole, on the basis of a clearance between an outer surface of the shaft and an inner surface of the mating hole in the second mating region.

6. The machine-part mating structure according to claim 5, satisfying the following relationship:
$$A 2 < A 1 < B$$
$$A 2 a < A 1 b$$
where B is an inner diameter of the mating hole, A1 is the outer diameter of the first mating region, A2 is the outer diameter of the second mating region, A2a is the outer diameter of the second mating region at the upper tolerance limit, and A1b is the outer diameter of the first mating region at the lower tolerance limit.

7. The machine-part mating structure according to claim 5, wherein the mating hole has the same reference dimension in a radial direction as the shaft.

8. The machine-part mating structure according to claim 7, satisfying the following relationship:
$$( A 1 a - A 2 b ) / As \leq 0.001$$
where As is the reference dimension of an outer diameter of the shaft, A1a is the outer diameter of the first mating region at the upper tolerance limit, A2b is the outer diameter of the second mating region at the lower tolerance limit.

9. The machine-part mating structure according to claim 1, wherein the maximum angle is 1° or less.

10. The machine-part mating structure according to claim 5, wherein the maximum angle is 1° or less.
